(19) United States
(12) Patent Application Publication
(10) Pub. No.: US 2025/0285246 A1
(43) Pub. Date: Sep. 11, 2025

(54) PLANAR HOMOGRAPHY DEVICE, AND PLANAR HOMOGRAPHY METHOD

(71) Applicant: NEC Corporation, Tokyo (JP)

(72) Inventor: Gaku NAKANO, Tokyo (JP)

(73) Assignee: NEC Corporation, Tokyo (JP)

(21) Appl. No.: 19/068,100

(22) Filed: Mar. 3, 2025

(30) Foreign Application Priority Data
Mar. 5, 2024 (JP) 2024-032931

(51) Int. Cl. G06T 5/80; G06T 5/50

(52) U.S. Cl. CPC G06T 5/80; G06T 5/50

(57) ABSTRACT

The planar homography device includes a calculation unit for calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image and a transformation unit for transforming the matrix representing the inverse transformation of planar homography into a matrix representing planar homography.

This application is based upon and claims the benefit of priority from the prior Japanese Patent Application No. 2024-032931, filed Mar. 5, 2024, the entire contents of which are incorporated herein by reference.

### BACKGROUND OF INVENTION

### Field of the Invention

This present disclosure relates to a planar homography device, a planar homography method, and a planar homography program.

### Description of the Related Art

Planar homography refers to a geometric representation method that associates a group of images taken of a certain three-dimensional plane from different positions. The parameters of the planar homography are represented by a 3×3 matrix (hereinafter referred to as the H matrix).

One of the important factors in the calculation of the H matrix is the lens distortion of the camera. As a related technology, Non-Patent Literature 1 discloses a method for simultaneously calculating the H matrix and the lens distortion coefficient.

[Non-Patent Literature 1] Fitzgibbon, Andrew W. “Simultaneous linear estimation of multiple view geometry and lens distortion.” Proceedings of the 2001 IEEE Computer Society Conference on Computer Vision and Pattern Recognition. CVPR 2001. Vol. 1. IEEE, 2001.

### SUMMARY OF INVENTION

However, the method described in Non-Patent Literature 1 may not calculate the H matrix and the lens distortion coefficient optimally, leaving room for improvement.

An example of an objective of the present disclosure is to provide a planar homography device, a planar homography method, and a planar homography program that solve the above problem and calculate the H matrix and the lens distortion coefficient optimally.

To achieve the above objective, a planar homography device according to one aspect of the present disclosure includes a calculation unit for calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image and a transformation unit for transforming the matrix representing the inverse transformation of planar homography into a matrix representing planar homography.

Additionally, to achieve the above objective, a planar homography method according to one aspect of the present disclosure includes calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image and transforming the matrix representing the inverse transformation of planar homography into a matrix representing planar homography.

Furthermore, to achieve the above objective, a planar homography program according to one aspect of the present disclosure for causing a computer to execute processing includes calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image and transforming the matrix representing the inverse transformation of planar homography into a matrix representing planar homography.

According to the present disclosure, it is possible to optimally calculate the H matrix and the lens distortion coefficient.

### BRIEF DESCRIPTION OF THE DRAWINGS

FIG. 1 It depicts a block diagram showing an example of a functional configuration of a planar homography device.

FIG. 2 It depicts a flowchart showing an example of an operation of the planar homography device.

FIG. 3 It depicts a diagram explaining a specific example of a projective transformation using the calculated H matrix and lens distortion coefficient.

FIG. 4 It depicts a diagram showing an example of a hardware configuration of the planar homography device.

FIG. 5 It depicts a block diagram illustrating main components of a planar homography device.

### DESCRIPTION OF THE PREFERRED EMBODIMENTS

Hereinafter, example embodiments in this present disclosure will be explained with reference to the drawings.

Assume a scenario where a plane with a specific pattern printed on it (hereinafter referred to as the reference plane, and its front-view image as the reference image) is captured by a camera from multiple angles. In this case, it is known that the H matrix between the reference plane and each image (hereinafter referred to as captured image) can be calculated, and by decomposing the H matrix, internal parameters of the camera (for example, focal length, lens distortion, optical center) and external parameters (for example, rotation matrix, translation vector) can be calculated (refer to Document 1: Zhang, Zhengyou. “A flexible new technique for camera calibration.” IEEE Transactions on pattern analysis and machine intelligence 22.11 (2000): 1330-1334). This is called the Zhang method and is widely known as the most basic method for camera calibration in computer vision.

Document 2 (U.S. Pat. No. 9,519,968) discloses a method for improving the accuracy of the Zhang method using a depth camera. Document 3 (Japanese Patent No. 5989113) discloses a method for extending the Zhang method by capturing multiple reference planes for camera calibration. Document 4 (Japanese Patent No. 6429466) discloses a method for calculating the external parameters of a camera by capturing a reference plane with a camera of known internal parameters and decomposing the H matrix. Document 5 (H. Niitsuma, P. Rangarajan and K. Kanatani, High accuracy homography computation without iterations, Proceedings of the 16th Symposium on Sensing via Imaging Information (SSII 2010), June 2010, Yokohama, Japan, pp. IS2-05-1-IS2-05-8.) discloses a method for high-accuracy estimation of the H matrix using the Taubin method, known for fitting ellipses or estimating the fundamental matrix (F matrix).

One important factor in calculating the H matrix is the lens distortion of the camera. The 3×3 H matrix assumes that the lens distortion coefficient is zero. Therefore, for example, when the reference plane is captured using a camera equipped with a wide-angle lens, the accuracy of estimating the H matrix may decrease. This is because the lens distortion causes structures that should be straight to appear curved in the image. The method described in Non-Patent Literature 1, which calculates the H matrix and the lens distortion coefficient simultaneously, first detects image feature points in the reference image and the captured image. Then, by matching these feature points, pairs of corresponding points are created. Finally, using five or more pairs of corresponding points, the H matrix and the lens distortion coefficient are calculated simultaneously.

However, the method for calculating the H matrix and the lens distortion coefficient described in Non-Patent Literature 1 has the following problems. First, since multiple values are calculated simultaneously, it is difficult to determine the values uniquely. Second, the calculation method using five or more pairs of corresponding points is an approximate least squares method, which lowers the estimation accuracy of the H matrix and the lens distortion coefficient.

The planar homography device in the present disclosure solves the above problems and uniquely calculates a high-accuracy H matrix and lens distortion coefficient based on a non-approximate least squares method.

### First Example Embodiment

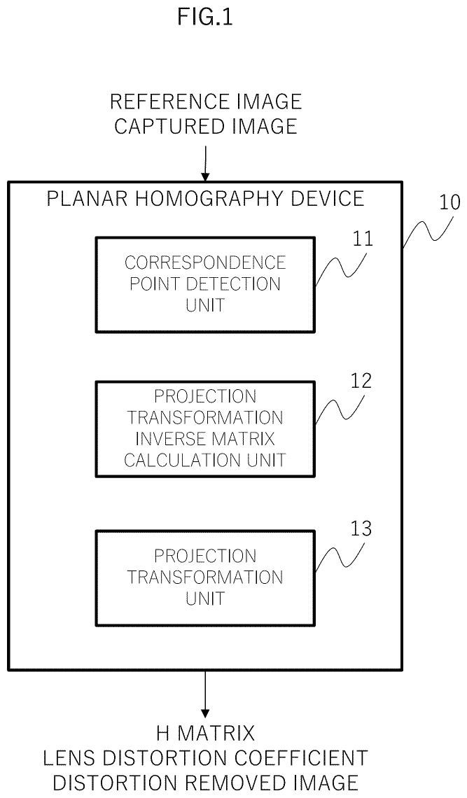

FIG. 1 is a block diagram showing an example of a functional configuration of a planar homography device according to this disclosure.

As shown in FIG. 1, a planar homography device 10 receives a reference image and a captured image as inputs and estimates an H matrix representing a planar homography between the reference image and the captured image, as well as a lens distortion coefficient of the captured image. The planar homography device 10 includes a correspondence point detection unit 11, a projection transformation inverse matrix calculation unit 12, and a projection transformation unit 13.

### (Device Configuration)

The correspondence point detection unit 11 receives a reference image and a captured image as inputs. Upon receiving the reference image and the captured image, the correspondence point detection unit 11 detects feature points from each image and outputs pairs of corresponding points where the difference between the feature vectors of the feature points is small. Existing techniques such as SIFT (Scale Invariant Feature Transform) or SURF (Speeded-Up Robust Features) can be used to calculate feature points and feature vectors.

The projection transformation inverse matrix calculation unit 12 calculates an inverse matrix of the H matrix (hereinafter referred to as the inverse H matrix) representing a planar homography from the reference image to the captured image, as well as a lens distortion coefficient of the camera that captured the captured image, using five or more pairs of corresponding points.

The projection transformation unit 13 transforms the inverse H matrix into an H matrix. Additionally, the projection transformation unit 13 removes lens distortion from the captured image using the H matrix and the lens distortion coefficient (or using only the lens distortion coefficient).

### (Device Operation)

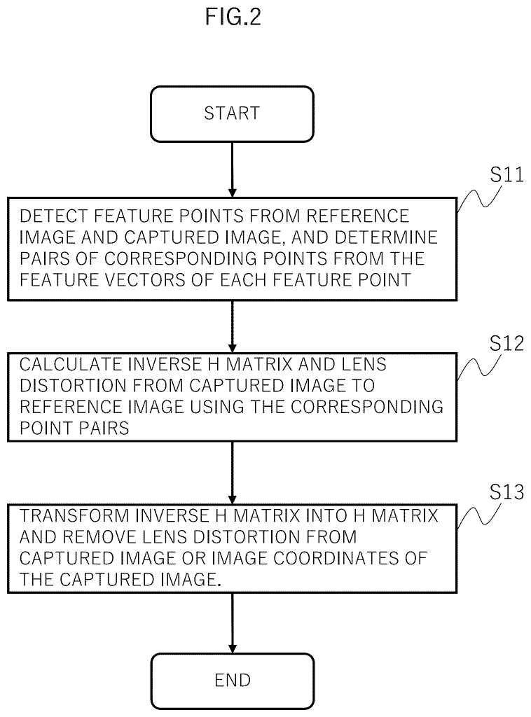

An example of an operation of the planar homography device 10 having the above configuration will be explained. FIG. 2 is a flowchart showing an example of an operation of the planar homography device.

In this example embodiment, a planar homography method is implemented by operating the planar homography device 10. Therefore, the explanation of the operation of the planar homography device 10 in this embodiment serves as an explanation of the planar homography method.

The planar homography device 10 inputs a reference image and a captured image. As shown in FIG. 2, the correspondence point detection unit 11 detects feature points from each image and outputs pairs of corresponding points where the difference in the feature vectors of the feature points is small (Step S11).

Next, the projection transformation inverse matrix calculation unit 12 inputs five or more pairs of corresponding points output by the correspondence point detection unit 11 and calculates an inverse H matrix and a lens distortion coefficient of the camera (Step S12).

Then, the projection transformation unit 13 inputs the captured image, the inverse H matrix, and the lens distortion coefficient calculated by the projection transformation inverse matrix calculation unit 12. The projection transformation unit 13 transforms the inverse H matrix into an H matrix. Additionally, the projection transformation unit 13 removes lens distortion from the captured image using the H matrix and the lens distortion coefficient (or using only the lens distortion coefficient). The projection transformation unit 13 then outputs the image with lens distortion removed from the captured image, the H matrix, and the lens distortion coefficient (Step S13).

In Step S13, for example, the projection transformation unit 13 applies the H matrix and lens distortion to the captured image to generate and output a front-view image. Alternatively, the projection transformation unit 13 may apply the H matrix and lens distortion to the image coordinates (for example, feature point coordinates) of the captured image and output only coordinate values subjected to planar homography. Furthermore, for example, the projection transformation unit 13 may apply only the lens distortion to the captured image and output the image with lens distortion removed (without front-view transformation).

### Specific Example

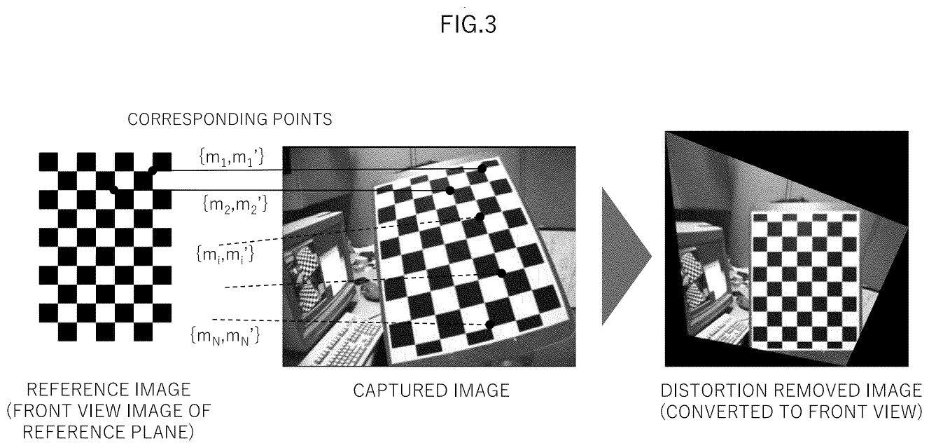

Here, a specific example of this example embodiment will be explained with reference to FIG. 3. FIG. 3 is a diagram explaining a specific example of planar homography. The reference image shown in FIG. 3 is a so-called checkerboard pattern. In FIG. 3, an image is shown in which the lens distortion of the captured image has been removed and converted to a front view image, using the correspondence points between the captured checkerboard image and the reference image. Note that the reference image and captured image shown in FIG. 3 are sourced from images published on OpenCV (https://opencv.org/).

In the following specific example, the 3×3 H matrix is denoted as H, the lens distortion coefficient as λ, the i-th feature point of the reference image as mᵢ=[xᵢ, yᵢ, 1]^{T}, and the corresponding feature point in the captured image as mᵢ′=[uᵢ, vᵢ, 1+λ×rᵢ²]^{T} (where rᵢ²=uᵢ²+vᵢ²). Here, the modeling of the lens distortion of the camera is performed according to the method described in Non-Patent Literature 1.

First, the case where the method described in Non-Patent Literature 1 is applied to this example embodiment will be explained.

For each pair of corresponding points {mᵢ, mᵢ′}, the planar homography represented by Equation (1) below holds.

$${{m}_{i}}^{′} ∼ {Hm}_{i} \qquad Equation ( 1 )$$

Here, “˜” indicates that the left and right sides are proportional by a constant factor. When N or more pairs of corresponding points {mᵢ, mᵢ′} (N≥5) are given, Equation (2) can be obtained

$$\begin{matrix}[ Math . 1 ] & \\ {D}_{1} h = λ {D}_{2} h & Equation ( 2 )\end{matrix}$$

$${D}_{1} = [ \begin{matrix}{0}_{1 \times 3} & - {m}_{1}^{T} & {v}_{1} {m}_{1}^{T} \\ {m}_{1}^{T} & {0}_{1 \times 3} & - {u}_{1} {m}_{1}^{T} \\ & ⋮ & \\ {0}_{1 \times 3} & - {m}_{N}^{T} & {v}_{N} {m}_{N}^{T} \\ {m}_{N}^{T} & {0}_{1 \times 3} & - {u}_{N} {m}_{N}^{T}\end{matrix} ]$$

$${D}_{2} = [ \begin{matrix}{0}_{1 \times 3} & {r}_{1}^{2} {m}_{1}^{T} & {0}_{1 \times 3} \\ - {r}_{1}^{2} {m}_{1}^{T} & {0}_{1 \times 3} & {0}_{1 \times 3} \\ & ⋮ & \\ {0}_{1 \times 3} & {r}_{N}^{2} {m}_{N}^{T} & {0}_{1 \times 3} \\ - {r}_{N}^{2} {m}_{N}^{T} & {0}_{1 \times 3} & {0}_{1 \times 3}\end{matrix} ]$$

Here, h represents the H matrix transformed into a 9-dimensional vector. When there are five or more pairs of corresponding points, the number of rows in D₁ and D₂ is 2×N, which exceeds the number of columns (that is, the dimensionality of h). This results in an overdetermined system. Therefore, the system is transformed as shown in Equation (3) below to align the number of rows and columns.

$$\begin{matrix}[ Math . 2 ] & \\ ( {D}_{1}^{T} {D}_{1} ) h = λ ( {D}_{1}^{T} {D}_{2} ) h & Equation ( 3 )\end{matrix}$$

From Equation (3), h is an eigenvector of a generalized eigenvalue problem with a 9×9 matrix. Therefore, λ can be calculated as the eigenvalue corresponding to the eigenvector.

The aforementioned solution in Non-Patent Literature 1 has the following problems. First, in a 9×9 generalized eigenvalue problem, there can be up to nine real solutions for the eigenvalues and eigenvectors. However, since any eigenvalue and eigenvector satisfy Equation (3), it is impossible to uniquely determine the solution. Next, to obtain the least squares solution of Equation (2), one must solve the problem expressed by Equation (4) below instead of Equation (3).

$$\begin{matrix}[ Math . 3 ] & \\ {min}_{h , λ} {‖ {D}_{1} h - λ {D}_{2} h ‖}^{2} & Equation ( 4 )\end{matrix}$$

$$s . t . {‖ h ‖}^{2} = 1$$

That is, Equation (3) is an approximate solution to Equation (4) and not the solution to the correct optimization problem.

Next, a specific example of applying the planar homography device in this example embodiment will be explained. First, in Equation (1), the inverse transformation of the H matrix is expressed by Equation (5) below.

$$\begin{matrix}[ Math . 4 ] & \\ {H}^{- 1} {m}_{i}^{′} ∼ {m}_{i} ↔ G ∼ {m}_{i} & Equation ( 5 )\end{matrix}$$

$$G = [ λ {h}_{3}^{- 1} {H}^{- 1} ]$$

$$= {[ {r}_{i}^{2} , {u}_{i} , {v}_{i} , 1 ]}^{T}$$

Here, h₃⁻¹ represents the third column of the inverse H matrix (H⁻¹). G is a 3×4 matrix composed of λ, h₃⁻¹, and H⁻¹.

First, assume that five pairs of corresponding points {mᵢ, mᵢ′} (i={1, 2, 3, 4, 5}) are given. In this case, the following Equation (6) is obtained.

$$\begin{matrix}[ Math . 5 ] & \\ Mg = 0 & Equation ( 6 )\end{matrix}$$

$$M = [ \begin{matrix}{0}_{1 \times 4} & - {T}^{} & {y}_{1} {T}^{} \\ {T}^{} & {0}_{1 \times 4} & - {x}_{1} {T}^{} \\ & ⋮ & \\ {0}_{1 \times 4} & - {T}^{} & {y}_{5} {T}^{} \\ - {T}^{} & {0}_{1 \times 4} & - {x}_{5} {T}^{}\end{matrix} ]$$

Here, g represents the 12-dimensional vector form of the matrix G. Let the (j, k) component of H⁻¹ be denoted as aⱼₖ. Then, g=[λa₁₃, a₁₁, a₁₂, a₁₃, λa₂₃, a₂₁, a₂₂, a₂₃, λa₃₃, a₃₁, a₃₂, a₃₃]^{T}.

M is a 10×12 matrix. The 9×12 submatrix from the first row to the ninth row of M is referred to as M₁, and the tenth row is referred to as M₂. M₁ has a 3×12 null space V. The vector g can be expressed as a linear combination of the columns of the null space of M₁, g=Mz. Here, z=[α, β, γ]^{T} represents unknown coefficient. Since multiplying the fourth, eighth, and twelfth components of g by the lens distortion coefficient λ equals the second, fifth, and ninth components, respectively, the following Equation (7) is obtained.

$$\begin{matrix}[ Math . 6 ] & \\ [ \begin{matrix}λ {a}_{13} \\ λ {a}_{23} \\ λ {a}_{33} \\ {a}_{13} \\ {a}_{23} \\ {a}_{33}\end{matrix} ] = [ \begin{matrix}{v}_{11} & {v}_{12} & {v}_{13} \\ {v}_{51} & {v}_{52} & {v}_{53} \\ {v}_{91} & {v}_{92} & {v}_{93} \\ {v}_{41} & {v}_{42} & {v}_{43} \\ {v}_{81} & {v}_{82} & {v}_{83} \\ {v}_{12 , 1} & {v}_{12 , 2} & {v}_{12 , 3}\end{matrix} ] [ \begin{matrix}α \\ β \\ γ\end{matrix} ] & Equation ( 7 )\end{matrix}$$

$$\to [ \begin{matrix}λ {h}_{3}^{- 1} \\ {h}_{3}^{- 1}\end{matrix} ] = [ \begin{matrix}{A}_{3 \times 3} \\ {B}_{3 \times 3}\end{matrix} ] z$$

$$\to λ {h}_{3}^{- 1} = Az , {h}_{3}^{- 1} = Bz$$

$$\to λ z = {B}^{- 1} Az$$

Here, vⱼₖ represents the (j, k) component of the null space V. From Equation (7), z is the eigenvector of B⁻¹A, and λ is the eigenvalue corresponding to the eigenvector. Once z is obtained, g can be calculated from g=Mz. Here, z and λ can have up to three real solutions, but from Equation (6), the g that minimizes the absolute value of M₂g should be selected.

Once the vector g is obtained, the second to fourth columns of the matrix G correspond to the inverse H matrix, according to Equation (5). Since the inverse H matrix is a 3×3 matrix, the H matrix can be easily calculated.

Next, assume that N pairs of corresponding points {mᵢ, mᵢ′} (N≥6) are given. In this case, the vector g is the solution of the linear least squares method represented by the following Equation (8).

$$\begin{matrix}[ Math . 7 ] & \\ {min}_{g} {‖ Mg ‖}^{2} & Equation ( 8 )\end{matrix}$$

$$s . t . {‖ g ‖}^{2} = 1$$

Here, M is a 2N×12 matrix derived by extending Equation (6). As is well known in the standard calculation of the H matrix without lens distortion (DLT method), the optimal solution g of Equation (8) corresponds to the eigenvector associated with the smallest eigenvalue of M^{T}M. Once the vector g is obtained, the H matrix can be determined as explained above.

Additionally, as previously mentioned, multiplying the fourth, eighth, and twelfth components of the vector g by the lens distortion coefficient λ makes them equal to the second, fifth, and ninth components, respectively. Therefore, once the vector g is determined, the lens distortion coefficient λ can be calculated. For example, when the fourth component has the largest absolute value among the fourth, eighth, and twelfth components, λ can be obtained by dividing the second component by the fourth component. Using the component with the largest absolute value ensures numerical stability.

Once the lens distortion coefficient λ is obtained, the coordinate values of the captured image with lens distortion removed can be calculated using the following Equation (9)

$${u}_{i} ← {u}_{i} / ( 1 + λ \times {{r}_{i}}^{2} ) \qquad Equation ( 9 )$$

$${v}_{i} ← {v}_{i} / ( 1 + λ \times {{r}_{i}}^{2} )$$

The specific examples above will be explained in conjunction with an operation of the planar homography device 10. First, in Step S11, the correspondence point detection unit 11 performs feature point matching using, for example, SIFT. The correspondence point detection unit 11 then outputs five or more pairs of corresponding points {mᵢ, mᵢ′} from the respective images.

Next, in Step S12, the projection transformation inverse matrix calculation unit 12 calculates an inverse H matrix and a lens distortion coefficient λ based on Equations (6) through (7) when there are five pairs of corresponding points. When there are six or more pairs of corresponding points, the projection transformation inverse matrix calculation unit 12 calculates an inverse H matrix and a lens distortion coefficient λ based on Equation (8). The projection transformation inverse matrix calculation unit 12 then outputs the calculated inverse H matrix and lens distortion coefficient λ.

Finally, in Step S13, the projection transformation unit 13 calculates an H matrix from the inverse H matrix and calculates coordinate values of the captured image with lens distortion removed based on Equation (9). The projection transformation unit 13 then outputs the captured image with lens distortion removed, the H matrix, and the lens distortion coefficient λ.

Above as explained, according to this example embodiment, it is possible to uniquely calculate a high-accuracy H matrix and lens distortion coefficient based on a least squares method without approximations. That is, according to this example embodiment, it is possible to optimally calculate the H matrix and the lens distortion coefficient. The reasons are as follows.

First, as explained in Equations (2) through (4), when using the method described in Non-Patent Literature 1, up to nine solutions may exist, making it impossible to determine a unique solution. However, in this example embodiment, in Step S12, the projection transformation inverse matrix calculation unit 12 calculates the inverse H matrix and the lens distortion coefficient λ based on Equations (6) through (7) when there are five pairs of corresponding points. Additionally, when there are six or more pairs of corresponding points, the projection transformation inverse matrix calculation unit 12 calculates the inverse H matrix and the lens distortion coefficient λ based on Equation (8). Therefore, according to this example embodiment, it is possible to determine a unique solution whether there are five pairs or six or more pairs of corresponding points.

Next, the method described in Non-Patent Literature 1 based on Equation (1) does not solve the optimization problem represented by Equation (4), making it an approximate solution. However, in this example embodiment, the optimization problem based on Equation (5), expressed via the inverse H matrix, is solved according to Equation (8). That is, in this example embodiment, the projection transformation inverse matrix calculation unit 12 calculates the inverse H matrix and the lens distortion coefficient λ using a linear least squares method. The projection transformation unit 13 then calculates the H matrix from the inverse H matrix. Therefore, according to this example embodiment, it is possible to calculate a high-accuracy H matrix and lens distortion coefficient based on a least squares method without approximations. As a result, it is possible to optimally remove lens distortion from the captured image using the calculated H matrix and lens distortion coefficient.

### (Modifications)

This example embodiment is not limited to the above examples. Various modifications that would be understood by those skilled in the art can be applied to this example embodiment. For example, this example embodiment can also be implemented in the forms explained in the following modifications.

### (Modification 1)

In the projection transformation inverse matrix calculation unit 12, the method using six or more pairs of corresponding points is not limited to the linear least squares method represented by Equation (8). For example, the Taubin method described in Document 5 can be used. This may improve the estimation accuracy of the H matrix.

### (Modification 2)

For example, assume a case where there are erroneous corresponding points (so-called mismatched points or outliers). In this case, the projection transformation inverse matrix calculation unit 12 may incorporate a robust estimator such as RANSAC (Random Sample Consensus) or an M-estimator by combining the method using five pairs of corresponding points and the method using six or more pairs of corresponding points. By doing so, erroneous corresponding points can be removed, and a highly accurate H matrix can be calculated by ultimately applying the method for six or more pairs to only the correct corresponding points.

### (Program)

The program in this example embodiment only needs to cause a computer to execute the processing in Steps S11 to S13 shown in FIG. 2. By installing and executing this program on a computer, it is possible to implement the planar homography device and the planar homography method in this example embodiment.

### Other Example Embodiment

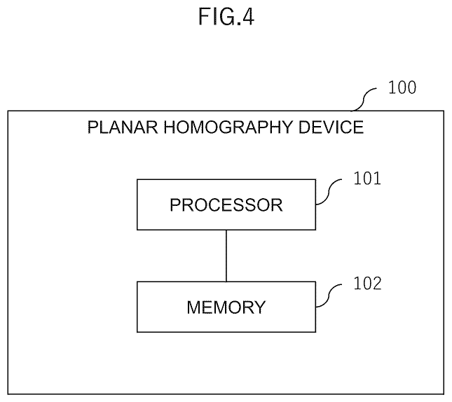

FIG. 4 is a diagram showing an example of the hardware configuration of the planar homography device. In FIG. 4, the planar homography device 100 includes a processor 101 and a memory 102. The processor 101 may be, for example, a microprocessor, an MPU (Micro Processing Unit), or a CPU (Central Processing Unit). The processor 101 may include multiple processors. The memory 102 is configured from a combination of volatile and non-volatile memory. The memory 102 may include storage located remotely from the processor 101. In this case, the processor 101 may access the memory 102 via an I/O interface (not shown).

The planar homography device 10 in the first example embodiment can have the hardware configuration shown in FIG. 4. The correspondence point detection unit 11, the projection transformation inverse matrix calculation unit 12, and the projection transformation unit 13 in the planar homography device 10 in the first example embodiment may be implemented by causing the processor 101 to read and execute a program stored in the memory 102. The program can be stored using various types of non-transitory computer-readable media and supplied to the planar homography device. Examples of non-transitory computer-readable media include magnetic recording media (for example, flexible disks, magnetic tapes, hard disk drives), magneto-optical recording media (for example, magneto-optical disks). Further examples of non-transitory computer-readable media include CD-ROM (Read Only Memory), CD-R, and CD-R/W. Further, examples of non-transitory computer-readable media include semiconductor memory, such as mask ROM, PROM (Programmable ROM), EPROM (Erasable PROM), flash ROM, and RAM (Random Access Memory). In addition, the program may be supplied to the planar homography device via various types of transitory computer-readable media. Examples of transitory computer-readable media include electrical signals, optical signals, and electromagnetic waves. Transitory computer-readable media can supply the program to the planar homography device 10 via wired communication paths, such as electrical wires or optical fibers, or via wireless communication paths.

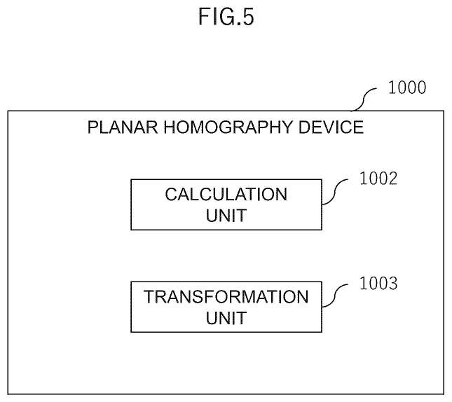

Next, an overview of this disclosure will be explained. FIG. 5 is a block diagram illustrating main components of a planar homography device. As shown in FIG. 5, the planar homography device 1000 (for example, corresponding to the planar homography device 10) includes: a calculation unit 1002 (implemented as the projection transformation inverse matrix calculation unit 12 in the example embodiment) for calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and a transformation unit 1003 (implemented as the projection transformation unit 13 in the example embodiment) for transforming the matrix representing the inverse transformation of planar homography into a matrix representing planar homography. With such a configuration, it is possible to calculate a high-accuracy matrix representing planar homography and lens distortion coefficient based on a least squares method without approximations. As a result, it is possible to optimally calculate the matrix representing planar homography and the lens distortion coefficient.

As explained above with reference to the example embodiments, this disclosure is not limited to the above example embodiments. Various changes that would be understood by those skilled in the art can be made within the scope of this disclosure. Each example embodiment can be combined with other example embodiments as appropriate.

The drawings are merely examples for explaining one or more example embodiments. Each drawing is not necessarily associated with only one particular example embodiment; it may be associated with one or more other example embodiments. As would be understood by those skilled in the art, the various features or steps explained with reference to one drawing can be combined with the features or steps shown in one or more other drawings to produce an example embodiment that is not explicitly shown or explained. Not all of the features or steps shown in one drawing are necessarily essential, and some features or steps may be omitted. The order of the steps described in any drawing may be changed as appropriate.

Some or all of the above-described example embodiments may be described as in the following Supplementary notes, but are not limited thereto.

(Supplementary note 1)

A planar homography device including:
a calculation unit for calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
a transformation unit for transforming the matrix representing the inverse transformation of planar homography into a matrix representing planar homography.

### (Supplementary Note 2)

The planar homography device according to Supplementary note 1, wherein the calculation unit calculates, using different methods, the matrix representing the inverse transformation of planar homography and the lens distortion coefficient, depending on whether there are five sets of correspondence point information or six or more sets of correspondence point information.

### (Supplementary Note 3)

The planar homography device according to Supplementary note 1 or Supplementary note 2, wherein,
when there are six or more sets of correspondence point information, the calculation unit calculates, using the Taubin method, the matrix representing the inverse transformation of planar homography and the lens distortion coefficient.

### (Supplementary Note 4)

The planar homography device according to Supplementary note 1 or Supplementary note 2, wherein,
when there are six or more sets of correspondence point information, the calculation unit excludes erroneous correspondence point information using a robust estimator and calculates the matrix representing the inverse transformation of planar homography and the lens distortion coefficient using correct correspondence point information.

### (Supplementary Note 5)

The planar homography device according to any one of supplementary notes 1 to 4, wherein the transformation unit removes lens distortion from the captured image using the matrix representing planar homography and the lens distortion coefficient.

### (Supplementary Note 6)

The planar homography device according to Supplementary note 5, wherein
the transformation unit generates an image from which lens distortion has been removed from the captured image.

### (Supplementary Note 7)

The planar homography device according to Supplementary note 5, wherein the transformation unit outputs coordinate values of the captured image from which lens distortion has been removed.

### (Supplementary Note 8)

The planar homography device according to any one of supplementary notes 1 to 7, further comprising
a correspondence point detection unit for detecting the correspondence point information between the reference image obtained by capturing the reference plane from the front view and the captured image obtained by capturing the reference plane from the angle different from the front view.

### (Supplementary Note 9)

A planar homography method performed by a computer and including:
calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transforming the matrix representing the inverse transformation of planar homography into a matrix representing planar homography.

### (Supplementary Note 10)

A planar homography program for causing a computer to execute processing including:
calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transforming the matrix representing the inverse transformation of planar homography into a matrix representing planar homography.

### (Supplementary Note 11)

A non-transitory computer-readable storage medium storing a planar homography program for causing a computer to execute processing including:
calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transforming the matrix representing the inverse transformation of planar homography into a matrix representing planar homography.

Some or all of the elements (such as configurations and functions) described in Supplementary notes 2 to 8, which depend on Supplementary note 1, can also be dependent on Supplementary notes 9, 10, and 11 in the same manner as Supplementary notes 2 to 8. Some or all of the elements described in any Supplementary note can be applied to various hardware, software, recording means for storing software, systems, and methods.

This disclosure is suitable, for example, for applications such as camera calibration and AR (Augmented Reality) that utilize the H matrix.

1. A planar homography device comprising:
a memory storing software instructions; and
one or more processors configured to execute the software instructions to:
calculate, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transform the matrix representing the inverse transformation of planar homography into a matrix representing planar homography.

2. The planar homography device according to claim 1, wherein
the one or more processors calculate, using different methods, the matrix representing the inverse transformation of planar homography and the lens distortion coefficient, depending on whether there are five sets of correspondence point information or six or more sets of correspondence point information.

3. The planar homography device according to claim 1, wherein,
when there are six or more sets of correspondence point information, the one or more processors calculate, using the Taubin method, the matrix representing the inverse transformation of planar homography and the lens distortion coefficient.

4. The planar homography device according to claim 1, wherein,
when there are six or more sets of correspondence point information, the one or more processors exclude erroneous correspondence point information using a robust estimator and calculate the matrix representing the inverse transformation of planar homography and the lens distortion coefficient using correct correspondence point information.

5. The planar homography device according to claim 1, wherein
the one or more processors remove lens distortion from the captured image using the matrix representing planar homography and the lens distortion coefficient.

6. The planar homography device according to claim 5, wherein
the one or more processors generate an image from which lens distortion has been removed from the captured image.

7. The planar homography device according to claim 5, wherein
the one or more processors output coordinate values of the captured image from which lens distortion has been removed.

8. The planar homography device according to claim 1, wherein the one or more processors are further configured to execute the software instructions to
detect the correspondence point information between the reference image obtained by capturing the reference plane from the front view and the captured image obtained by capturing the reference plane from the angle different from the front view.

9. A planar homography method performed by a computer and comprising:
calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transforming the matrix representing the inverse transformation of planar homography into a matrix representing planar homography.

10. A non-transitory computer-readable storage medium storing a planar homography program for causing a computer to execute processing comprising:
calculating, using five or more sets of correspondence point information between a reference image obtained by capturing a reference plane from a front view and a captured image obtained by capturing the reference plane from an angle different from the front view, a matrix representing an inverse transformation of planar homography from the reference image to the captured image and a lens distortion coefficient of an imaging device that captured the captured image; and
transforming the matrix representing the inverse transformation of planar homography into a matrix representing planar homography.

11. The planar homography device according to claim 2, wherein,
when there are six or more sets of correspondence point information, the one or more processors calculate, using the Taubin method, the matrix representing the inverse transformation of planar homography and the lens distortion coefficient.

12. The planar homography device according to claim 2, wherein,
when there are six or more sets of correspondence point information, the one or more processors exclude erroneous correspondence point information using a robust estimator and calculate the matrix representing the inverse transformation of planar homography and the lens distortion coefficient using correct correspondence point information.

13. The planar homography device according to claim 2, wherein
the one or more processors remove lens distortion from the captured image using the matrix representing planar homography and the lens distortion coefficient.

14. The planar homography device according to claim 13, wherein
the one or more processors generate an image from which lens distortion has been removed from the captured image.

15. The planar homography device according to claim 13, wherein
the one or more processors output coordinate values of the captured image from which lens distortion has been removed.

16. The planar homography device according to claim 2, wherein the one or more processors are further configured to execute the software instructions to
detect the correspondence point information between the reference image obtained by capturing the reference plane from the front view and the captured image obtained by capturing the reference plane from the angle different from the front view.

17. The planar homography device according to claim 11, wherein
the one or more processors remove lens distortion from the captured image using the matrix representing planar homography and the lens distortion coefficient.

18. The planar homography device according to claim 12, wherein
the one or more processors remove lens distortion from the captured image using the matrix representing planar homography and the lens distortion coefficient.

19. The planar homography device according to claim 17, wherein
the one or more processors generate an image from which lens distortion has been removed from the captured image.

20. The planar homography device according to claim 17, wherein
the one or more processors output coordinate values of the captured image from which lens distortion has been removed.
